(19) United States
(12) Patent Application Publication
(10) Pub. No.: US 2007/0226483 A1
(43) Pub. Date: Sep. 27, 2007

(54) System and method for storing and/or transmitting emulated network flows

(76) Inventors: Dennis Cox, Austin, TX (US); William Keith Brewer, Austin, TX (US); Craig Cantrell, Austin, TX (US); Brent Cook, Pflugerville, TX (US); H.D. Moore, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/388,805

(22) Filed: Mar. 24, 2006

(51) Int. Cl. H04L 9/00

(52) U.S. Cl. 713/151

(57) ABSTRACT

A method of encoding network packets for storage and later transmitting emulated packets includes determining a protocol for the packet and validating the protocol as belonging to a list of recognized protocols. Upon validating the packet, a protocol attribute value from the packet is parsed and a dictionary is referenced using the protocol attribute value to obtain a binary encoding, which is stored as an encoded packet. The packet, for example, may be an HTTP protocol request packet and parsing may include parsing a TYPE attribute value where the TYPE attribute value indicates whether the packet is a GET, POST, PUT or OTHER type of HTTP request. The method may further include modifying environmental data in the packet when the packet is later generated for transmission on a network. The method may further include, for packets of unrecognized protocols, learning and creating an encoding for new protocols.

### BACKGROUND

1. Field of the Present Invention

The present invention generally relates to the field of data communication systems, and more particularly to a system and method for storing and transmitting emulated network flows for performance testing of data communications network components.

2. History of Related Art

In the field of computer networks, the need arises to add various data communications network components to a network or to replace various data communications network components presently on the applicable network in question. Examples of these data communications network components include, among other things, network switches, routers, load balancers, firewalls, and web servers, among many others.

Prior to adding to and/or replacing a network's components, however, it is desirable to test and validate the functionality of the applicable network components to ensure the network components will function properly when deployed on the applicable network. Failure to test and validate the functionality of the network components properly prior to implementation may result in the applicable network being adversely impacted. Similarly, it is desirable to model a proposed network expansion prior to implementation.

While it would be preferable to test and validate the functionality of the applicable network components utilizing real-time data flows in their intended environment (i.e., the actual network on which the network component will be deployed), such testing and validation is generally not practicable for a number of reasons. Typically, data security issues, network capacity issues, issues resulting from the possibility that the network may be rendered inaccessible because the network component under test failed, and related issues make it unlikely that the applicable network component can be tested and validated in a “live” environment. Consequently, the need arises to permit the off-line testing and validating of the applicable network component with network flows that most closely emulate the actual network flows on the network in question.

Conventional network test equipment utilizes traffic generators that are preset based (i.e., the tester creates sample flows for use in testing the applicable network component). This scheme does not always provide a method for emulating packets reflective of the flows on the network under test. Further, it may take a considerable amount of time to create the sample flows for testing purposes. Other network test equipment utilizes traffic generators that are storage based. Storage based generators record live flows from the network in question and save the contents of the network flows in storage. Although storage based generators are ideal in terms of in their ability to capture actual network traffic, the subsequently produced emulated flows are not real world because environment attributes are not the same due to “time” related parameters. Additionally, security concerns with the data associated with the network flows may render this scheme unusable. Further, storage and recording constraints make it impracticable for this scheme to record large amounts of data associated with the network flows.

More generally, there are many applications other than network testing for which it would be highly desirable to implement an efficient and dynamic technique for capturing, storing, and/or transmitting large amounts of network packet data. Data analysis, for example, is a broad area in which a dynamic technique for capturing and compressing large amounts of packet information would be highly beneficial. This area would include security analysis in which, for example, packet anomalies are identified for further scrutiny. In addition, data analysis applications would include pure statistical analysis to determine the composition of packet traffic on a given network. A technique for efficiently capturing and storing packet information would also be beneficial in the area of high speed network traffic. In applications where the rate of network traffic pushes the physical ability of the network to handle the traffic, the ability to compress packets has a great deal of utility.

Accordingly, it would be broadly beneficial to implement a system and method for the efficient storage and emulation of network data traffic.

### BRIEF DESCRIPTION OF THE DRAWINGS

Objects and advantages of the invention will become apparent upon reading the following detailed description and upon reference to the accompanying drawings in which:

FIG. 1 is a flow diagram illustrating a method of encoding network flows according to one embodiment of the present invention;

FIG. 2 conceptually depicts one embodiment of a protocol table of the present invention;

FIG. 3 conceptually depicts one embodiment of a dictionary of the present invention;

FIG. 4 conceptually depicts one embodiment of a network flow encoding storage of the present invention;

FIG. 5 conceptually depicts one embodiment of the dictionary for a protocol attribute of one embodiment of the present invention;

FIG. 6 conceptually depicts one embodiment of the dictionary for a protocol attribute of one embodiment of the present invention;

FIG. 7 conceptually depicts one embodiment of the dictionary for a protocol attribute of one embodiment of the present invention;

FIG. 8 is a flow diagram illustrating a method of encoding network flows associated with a superflow according to one embodiment of the present invention; and

FIG. 9 illustrates an exemplary implementation of a change control dictionary according to an embodiment of the invention;

FIG. 10 depicts selected elements of a data processing system suitable for use as a data flow encoder;

FIG. 11 depicts selected elements of a data processing network including a data flow encoder of FIG. 10;

FIG. 12 depicts a flow diagram of a protocol learning method; and

FIG. 13 depicts a flow diagram illustrating modification of environmental packet data.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the invention is limited only by the language of the appended claims.

### DETAILED DESCRIPTION OF THE INVENTION

Generally speaking, an embodiment of the present invention contemplates the processing and encoding of network flows so that the encoded results emulate the original network flows, but can be stored in significantly less storage than would otherwise be required for storing the original network flows. Once encoded, characteristics and attributes of the stored network flows may be examined and, if desired, manipulated to facilitate the emulation of different network flows. The stored encodings of the network flows may be decoded and transmitted for purposes of testing network components. Throughout the description and the drawings, elements which are the same will be accorded the same reference numerals.

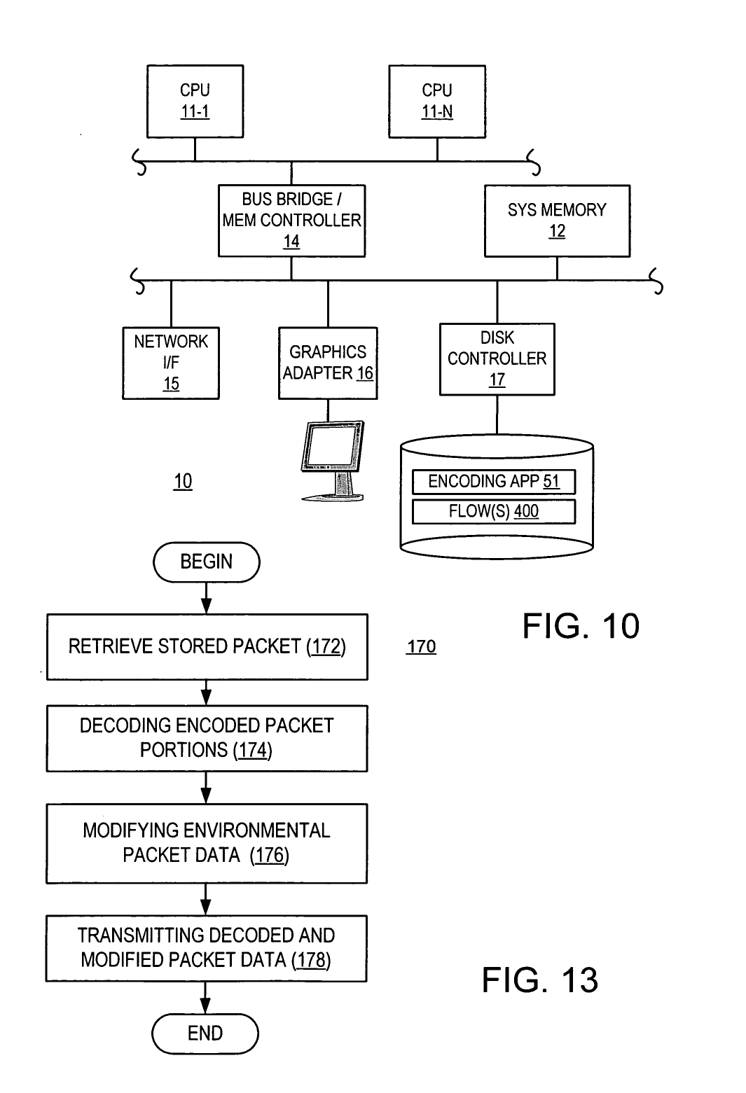

Before discussing details of a method of processing and encoding network flows, a description of a suitable hardware platform and application environment is described with respect to FIG. 10 and FIG. 11. FIG. 10 depicts selected elements of a data flow encoder 10 according to one embodiment. Data flow encoder 10 may be suitably implemented in a desktop or laptop computer system. In the depicted embodiment, data flow encoder 10 includes one or more general purpose central processing units 11-1 through 11-n (generically or collectively referred to as CPU(s) 11). CPUs 11 connect to a system memory 12 through an intervening bus bridge/memory controller 14. The bus bridge/memory controller 14 also connects to a peripheral bus (e.g., a PCI bus) to which one or more peripheral or I/O adapters are connected. In the depicted embodiment, the peripheral adapters of data flow encoder 10 include a network interface 15, a graphics adapter 16, and a disk controller 17 connected to a hard disk 18. Disk 18 contains an encoding application 50 and network flow encoding storage 400. Encoding application 50 represents computer executable instructions, stored on a computer readable media, that, when executed by CPU 11, perform the flow encoding method 100 described in greater detail below.

FIG. 11 depicts an exemplary application for using data flow encoder 10 of FIG. 10. In the application depicted in FIG. 11, data flow encoder 10 is connected to a communication link between an intranet or LAN 20 and a gateway device 30 that connects LAN 20 to the Internet or wide area network 40. In this implementation, data flow encoder 10 is operable to monitor packets flowing between gateway 30 and LAN 20. A myriad of other applications will readily be appreciated by those skilled in the field of network devices and network architecture.

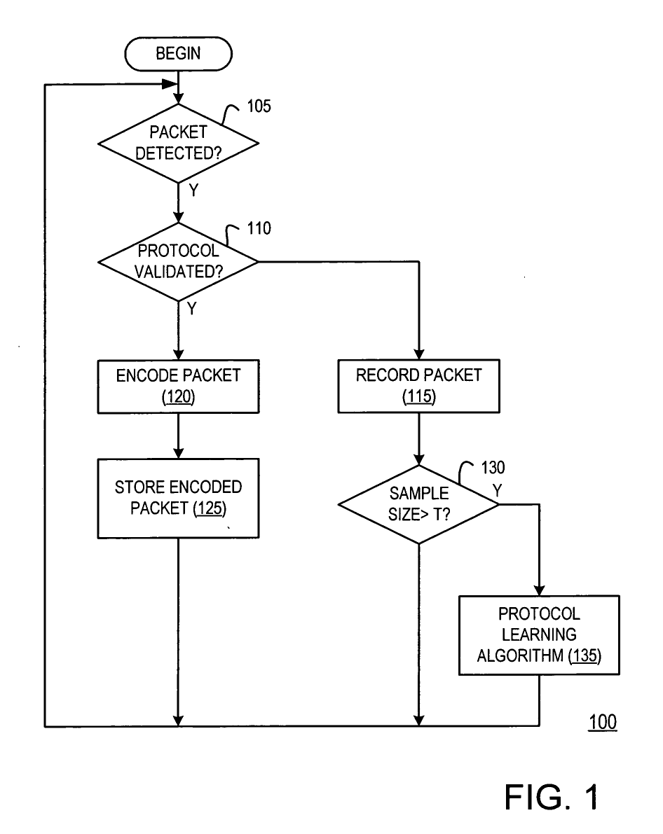

FIG. 1 depicts a flow diagram illustrating an embodiment of a method 100 for processing and encoding of network flows so that the encoded results emulate the original network flows, but can be stored in significantly less storage than the original network flows. As used herein, the term “network flow” is to be broadly read as a potentially bi-directional sequence of packets, typically closely spaced in time, that share certain common characteristics including, as examples, the same pair of source and destination addresses and/or port number, a protocol type, or the like. Examples of network flows include, but are not limited to, an HTTP GET request packet and all packets resulting from the GET request including one or more HTTP responses and, potentially, one or more additional or subsequent requests packets. Also, as used herein, the term “storage” is to be broadly read as both volatile computer memory (e.g., RAM) and non-volatile computer memory and storage such as floppy diskette, hard disk, flash memory, ROM, CD ROM, DVD, magnetic media, optical media, and other storage media well known in the art.

Frequent reference is made to protocols throughout this specification. Generally, in computer networks, a protocol is a convention or standard that controls the connection, communication, and data transfer between two computing endpoints. Network communication typically involves multiple protocols that are “layered” in a “protocol stack.” The protocol stack includes lower layers that define the physical network medium and addressing, communication, and transport issues. Examples of other communication or transport layer protocols include, but are not limited to, Real-time Transport Protocol (“RTP”), Sequenced Packet Exchange (“SPX”), Stream Control Transmission Protocol (“SCTP”), and User Datagram Protocol (“UDP”). Examples of lower level protocols include Transmission Control Protocol (TCP) and the Internet Protocol (IP), which are frequently layered together in a TCP/IP stack such as is utilized on the Internet.

Layered over these lower level protocols in a typical protocol stack are the application layers, which define or specify more abstract concepts such as commands and data. One popular component of the Internet is the World Wide Web (“WWW” or “web”) which is a collection of resources on servers on the Internet that utilize the Hypertext Transfer Protocol (“HTTP”) application layer protocol. HTTP is suitable for controlling access to resources on the web. Like many application layer protocols, HTTP uses a client-server model. In the client-server model, an HTTP client, such as a remote user, opens a connection and sends a request message to an HTTP server, such as a web server, which then responds with a message to the client. While HTTP utilizes an ASCII Text format, it will be appreciated by those skilled in the art that many protocols are not in human readable form. Examples of other application layer protocols include, but are not limited to, Apple Filing Protocol (“AFP”), Domain Name Service (“DNS”); Dynamic Host Configuration Protocol (“DHCP”); File Transfer Protocol (“FTP”); Internet Message Access Protocol (“IMAP”); News Network Transfer Protocol (“NNTP”); Simple Mail Transfer Protocol (“SMTP”); Simple Network Management Protocol (“SNMP”); and Trivial File Transfer Protocol (“TFTP”). Specifications for all of these protocols are generally defined and maintained by the Interent Engineering Task Force (IETF) and are publicly available from the IETF web site (IETF.org). The listed protocols are merely exemplary of the some of the most pervasive protocols. The flow encoding and transmission methods described herein are not, however, limited to widely implemented protocols.

It is well known in the art that protocols generally have certain attributes that are defined as part of the applicable protocol and that remain constant across packets associated with the particular protocol. That is, packets associated with the particular protocol will comply with a protocol-specific format that defines the applicable attributes of the protocol. Further, a protocol may include specific types of packets that generally have the same applicable attributes of the protocol. For example, the HTTP protocol may be thought of as including request packets and response packets. Request packets and response packets have certain respective attributes that are of particular relevance for a method of encoding packets. For example, request packets may be classified as including a TYPE attribute, (which identifies the type of request), a HOST protocol attribute, (which indicates a host URL), and a USER-AGENT attribute, (which specifies information about the client that generated the request). By way of further example, HTTP response packets generally have their own defined protocol attributes including a response code attribute, a server TYPE attribute, a content TYPE attribute, and a content length attribute.

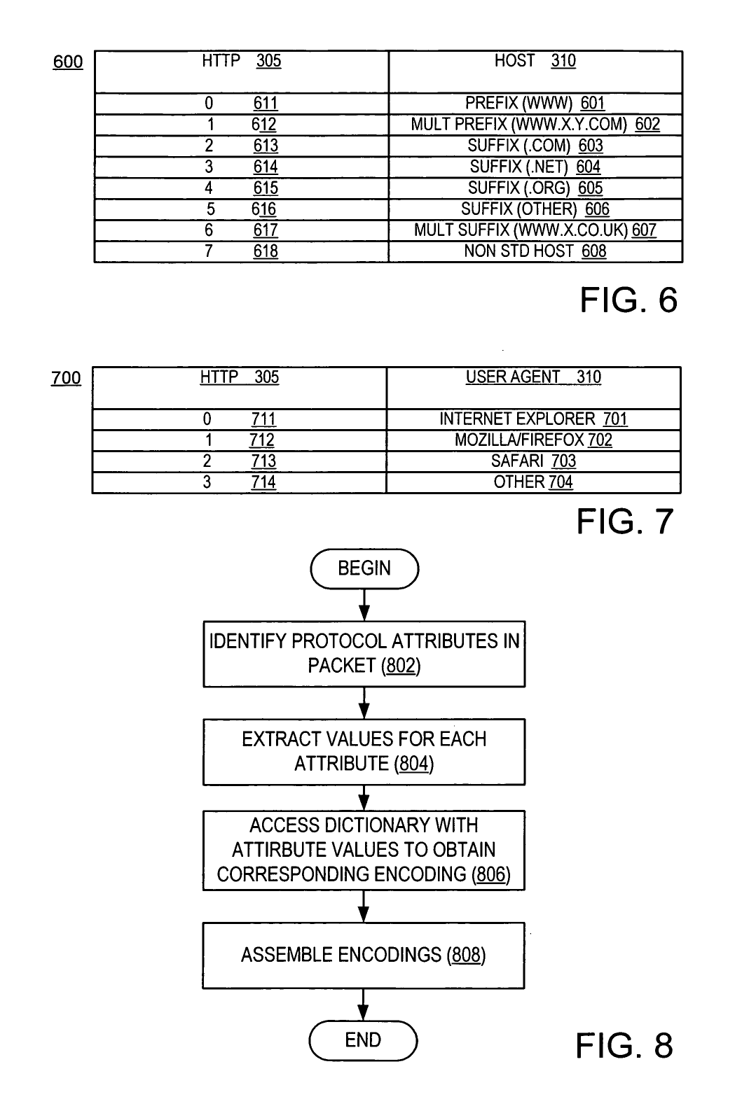

The allowable values for each attribute are generally pre-defined in accordance with the applicable protocol, and thus, generally there are either a limited number of values for the particular attribute or the majority of values for the particular attribute fall within a limited subset of possibilities. To illustrate, a set of predefined values associated with a TYPE attribute of a request packet transmitted under the HTTP protocol may be limited to the number of different types of requests that the HTTP protocol defines or fewer. Thus, predefined values associated with a TYPE attribute for an HTTP request may be limited to (1) GET, (2) POST, (3) PUT, or (4) OTHER. The TYPE attribute may include additional information such as whether the request specified a target URL and what protocol/version the request complies with. In this example, a TYPE attribute might indicate a packet as being an HTTP 1.1 GET request that specified a target URL. A second attribute may be a HOST protocol attribute that reflects information about the host URL specified in the request (see description of FIG. 6 below). A third attribute may be a USER/AGENT protocol attribute that indicates information about the client that generated the request (see description of FIG. 7 below).

As used herein, the term “protocol attribute” is to be broadly read as one or more characteristics representing defined fields or requirements for packets or network flows transmitted under a particular protocol and the term “attribute value” is to be broadly read as the predefined values, or a limited subset of values associated with, a particular protocol attribute. It will be appreciated by those skilled in the art that a protocol may be examined and relevant protocol attributes for the protocol determined.

Returning now to FIG. 1, when a packet of a network flow is detected (block 105), the protocol associated with the packet is examined (block 110) for validation. In one embodiment, validation includes determining whether the protocol is one of a selected set of recognized protocols. If the packet protocol is validated, the applicable attribute values and, if appropriate, data and information associated with the packet (“packet data”) is encoded (block 120) and stored (block 125) as described in greater detail below. Those skilled in the art will recognize that methods for examining packets to determine the applicable protocol for, and other information and data within, the packet are well known in the art.

If the protocol is not recognized or validated, however, the packet is recorded (block 115) “as is” by saving the packet to storage without encoding, encryption, or compression. The depicted embodiment of method 100 includes functionality for learning (block 135) protocols that were not validated or otherwise recognized in block 110. In the depicted implementation, packets that were not validated in block 110 are stored for subsequent protocol learning until a sufficient number of packets is available. In such implementation, a predefined or user selectable sample size “T” is chosen. Until T packets have been accumulated (block 130), method 100 merely records the packets by saving them to storage. The value of “T” is preferably chosen to ensure an adequate sample size without resulting in any significant loss of time and/or storage space. In many applications, for example, a sample size of approximately 1000 is generally thought to provide a proper balance between obtaining sufficient information and obtaining too much information. Of course, the value of T is an implementation detail and the value of T in any given application may be greater than or less than 1000. Once a sufficient number of a packets have been captured and stored, method 400 includes invoking or otherwise calling the learning algorithm represented by block 135.

In some embodiments, protocol learning algorithm 135 is implemented as a technique for discovering bit patterns in a sufficiently large sample of packets to make a conclusion about the bits. As a simple example, if every captured packet included a value of “1” in its first bit, the first bit could be disregarded for the purpose of storing the packet and later transmitting an emulated packet. Extending this example, if the first three bits of 95% of the captured packets contained a value of either 001, 010, or 101, the first three bits could be represented or encoded using a 2-bit representation where, for example, the value 001 is assigned an encoded value of 00, the value 010 is assigned a value of 01, the value 101 is assigned a value of 10, and any other values are assigned a value of 11. This exemplary encoding is characterized by a high degree of accuracy (i.e., the first three bits of 95% percent of packets can be reproduced exactly) but a relatively low level of compression. 3-bits have been encoded with 2-bits thereby saving a single bit. Generally, encoding in the described manner involves a tradeoff between accuracy and the amount of compression achievable. The amount of accuracy and compression required is an implementation detail.

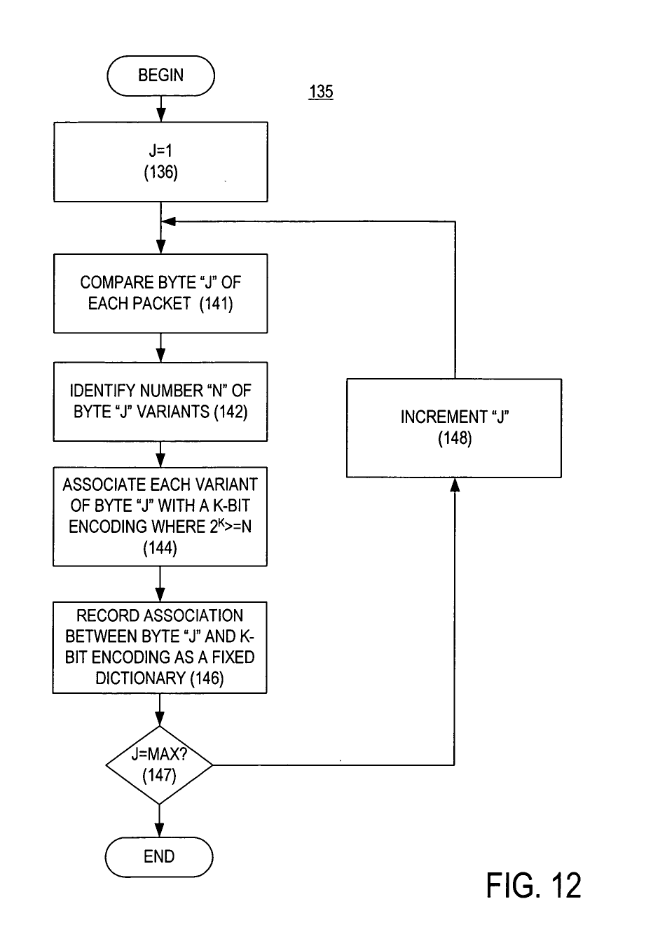

FIG. 12 shows selected elements of a block diagram of an embodiment of protocol learning algorithm 135 of FIG. 10. In the embodiment depicted in FIG. 12, protocol learning algorithm 135 includes an initialization (block 136) of a counter variable “J.” In block 141, the J-th byte of each packet in a sample of packets is compared and the number of variants or values of byte J is identified (block 142). The number of variants (N) may represent the exact number of different values detected in the sample of packets. In other embodiments, however, the number of variants may represent the number of variants required to match X % of the J-th bytes, where X is preferably close to, but less than, 100. In the implementation described in the preceding paragraph, for example, X is 95%, and the identification of block 142 would include determining the number of different types of J-th byte packets required to find a match for 95% of the total packets.

In block 144, protocol learning method 135 associates each of the variants identified in block 142 with a corresponding K-bit encoding, where 2^{K} is greater than or equal to N, and N is the number of variants as described above. This, for the example where the number of variants is 4, a unique 2-bit encoding may be assigned to each of the four variants. While this type of encoding is the most efficient in terms of the number of bits conserved, other encoding implementations are possible. For example, a four bit encoding might be used to encode the four values of the J-th byte with each bit in the four bit encoding representing one of the four J-th byte variants.

In block 146, the association between byte J and the corresponding K-bit encoding is recorded in a dictionary or other suitable data structure to preserve the encoding scheme. Blocks 141 through 146 are then repeated for each byte in the packet by comparing (block 147) J to a MAX variable that indicates the number of bytes in a packet and incrementing (block 148) J until all bytes in the packet have been processed.

In this manner, protocol learning method 135 provides functionality that enables the data encoder application to develop encodings for previously un-encountered protocols. It should be appreciated that the learning method 135 described in FIG. 12 is a specific implementation and that alternative implementations, such as the implementation referred to in which the identified variants of a packet byte are assigned unique bits in the encode representation, are possible. Similarly, although method 135 was described as operating on byte segments of a data packet, other implementations may operate on segments having more or fewer bits than a byte. Moreover, some embodiments of learning method 135 may conclude that encoding is not suitable with respect to certain bytes or groups of bytes. For example, a portion of a packet may contain random text. In such cases, learning method 135 may capture or represent the random text by either simply storing the length of the random text segment or by recording the random text segment without compression of other forms of encoding. In addition, although learning method 135 describes an automated, machine-driven method for developing new encodings, learning method 135 may be supplemented or replaced entirely by a manually developed encoding.

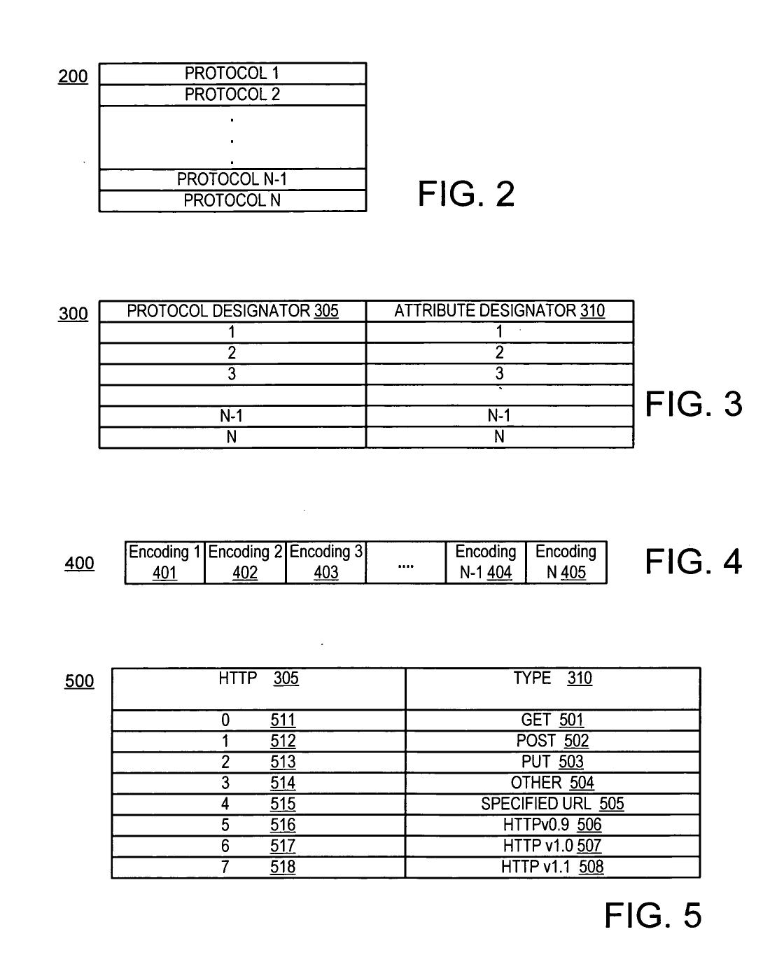

Returning now to the protocol verification of block 110 in FIG. 1, validation of a protocol occurs if one or more dictionaries are available for the applicable protocol. A generic example of a dictionary 300 is depicted in FIG. 3. In one embodiment, validation includes comparing a packet's protocol against a list of protocols contained in protocol table 200 (see FIG. 2). In the depicted implementation, protocol table 200 is a table or list containing information indicating protocols for which one or more dictionaries 300 are available. Protocol table 200 may be implemented utilizing a data table or other form of linked list. The entries in protocol table 200 are preferably not static, but rather may change over time as dictionaries 300 for additional protocols are added or removed.

As depicted in FIG. 3, dictionary 300 is a table or other form of data structure that includes a protocol designator 305, an attribute designator 310, a set of field indicators 320, and a corresponding set of predefined values 315. Protocol designator 305 and attribute designator 310 indicate the protocol attribute, respectively, to which dictionary 300 applies. In preferred embodiments, one or more dictionaries 300 are available for each of the protocol attributes associated with the protocols identified in protocol table 200. In the depicted implementation, dictionary 300 includes a set of single-bit field indicators 320 and a corresponding set of predefined values indicated by reference numeral 315. In this implementation, the value of each field indicator bit 320 (either a 0 or a 1) is indicative of a packet's contents with respect to the corresponding predefined value 315.

A dictionary 300 may be associated, for example, with an attribute of interest for an HTTP request. In this case, protocol designator 305 would be HTTP, attribute designator 310 would be the protocol attribute of interest, and the set of predefined values 315 may include entries reflecting different possible values for the HTTP request packet attribute of interest. If the dictionary 300 were a TYPE protocol attribute dictionary, for example, a first predefined value 315 might contain the value GET and a 1 or 0 in the corresponding field indicator 320 would indicate whether the corresponding packet is a GET request. In one embodiment, a 1 value in a field indicator bit 320 is an affirmative indicator with respect to the corresponding predefined value while a 0 value is a negative indicator with respect to the corresponding predefined value (e.g., the packet is either not of the value in the predefined value or the field is not applicable). In another embodiment, a 0 in the applicable field indicator is an affirmative indicator and a 1 in the applicable field indicator is a negative indicator.

Dictionaries 300 define an association between binary values and corresponding attribute values of a packet. In this manner, dictionaries 300 may be used to encode a packet by creating a set of binary values, each of which has a meaning defined by a corresponding dictionary, that is representative of or symbolic of a corresponding packet. Similarly, each packet in a set of packets representing a particular network flow could be encoded using the dictionaries such that the resulting encoded symbols use significantly less storage than would otherwise be required for storing the original information or data. It will be appreciated by those skilled in the art, that while the protocol attributes may vary by applicable protocol, predefined values 315 of each applicable dictionary reflect data or information that is common to the applicable protocol.

The depicted implementation of dictionary 300 includes a one to one correspondence between the predefined values 315 and the field indicators 320. In other embodiments, the number of predefined values 315 may exceed the number of field indicators 320. For example, an embodiment (not depicted) of dictionary 300 may employ 2-bit field indicators 310 to identify one of four corresponding predefined values 315 (i.e., 00 corresponding to the first of such predefined values, 01 corresponding to the second of such predefined values, 10 corresponding to the third of such predefined values, and 11 corresponding to the fourth of such predefined values). The ratio by which the number of predefined values 315 may exceed the number of field indicators 320 can be manipulated by employing appropriate encoding schemes.

Although dictionary 300 and the other dictionaries illustrated below are depicted as they would appear or exist at a particular point in time, dictionary 300 is preferably implemented as a dynamic dictionary having a format and/or structure capable of changing with time to reflect additional knowledge about the content of captured packets. As an example, the structure of dictionary 300 may initially define N categories of packet types, with one of the N packet types representing a “miscellaneous” category. After a period of time has elapsed and a greater number of packets have been received, analysis of the packets may reveal that an undesirably large percentage of packets were categorized in the miscellaneous category. In response, dictionary 300 may be altered, in some embodiments, to add one or more additional categories based on an analysis of the miscellaneous packets. Conversely, dictionary 300 may contract over time to achieve higher ratios of compression if the data supports it. If, for example, analysis of large amounts of packet data reveals a strong correlation between the value in a first portion (e.g., byte) of a packet and the value in another portion of the packet, a single encoding may be used to represent both portions.

Before returning to FIG. 1, a description of selected examples of dictionaries suitable for use with a method, such as method 100, for encoding network flows will be described with reference to FIG. 5, FIG. 6, and FIG. 7. The described implementation of method 100 extracts information with respect to three protocol attributes of request packets, namely, a TYPE attribute, a HOST protocol attribute, and a USER/AGENT protocol attribute. It will be appreciated that the encoding described below represents a particular implementation and is not intended to impose specific requirements on the encoding process. For example, although the dictionary 500 described below uses four bits to encode the type of HTTP request (GET, POST, PUT, and OTHER), alternative encoding implementations may use 2-bits to encode these four types of requests.

FIG. 5 depicts an implementation of a TYPE protocol attribute dictionary 500 suitable for encoding information about a TYPE attribute of an HTTP request packet. Dictionary 500 includes a value of HTTP for protocol designator 305 and a value of TYPE for attribute designator 310. Dictionary 500 includes a first set of predefined values 501 through 504 that indicate corresponding types of HTTP requests including a GET predefined value 501, a POST predefined value field 502, a PUT predefined value 503, and an OTHER predefined value 504. The value of the bit in field indicators 511 through 514 indicates whether the corresponding packet is a GET, POST, PUT, or other form of request. The TYPE protocol attribute dictionary 500 as depicted in FIG. 5 further includes a Specified URL predefined value 505 and a corresponding field indicator bit 515 that indicates whether a request packet included a target URL in the request. The TYPE protocol attribute dictionary 500 also includes predefined values 506 through 508 and corresponding field indicator bits 516 through 518 indicating the protocol and protocol version of the request (e.g., HTTP v0.9, HTTP v1.0, or HTTP v1.1).

FIG. 6 depicts an exemplary HOST protocol attribute dictionary 600. Dictionary 600 includes a value of HTTP for protocol designator 305 and a value of HOST for attribute designator 310. As depicted in FIG. 6, values associated with a HOST protocol attribute may include field indicators 611-618 and predefined value entries 601-608 that are useful in constructing the host URL associated with a request. As implemented in FIG. 6, for example, HOST protocol attribute dictionary 600 includes two prefix-related predefined values 601 and 602 and corresponding field descriptors 611 and 612 that indicate whether the prefix of the host URL contained in a request consists of “www” (field indicator 611) or whether the host URL contains a compound prefix or multiple prefixes (field indicator 612). HOST protocol attribute dictionary 600 as shown in FIG. 6 further includes five suffix-related predefined values 603 through 607 and corresponding field indicator bits 613-617 that indicate information about the host URL suffix (e.g., whether the suffix consists of .com (field indicator 613), .net (614), .org (615), some other singular suffix (616), or a compound suffix (617). Dictionary 600 as depicted also includes a predefined value entry 608 and a corresponding field indicator 618 to indicate a non-standard host URL. In one embodiment, the domain portion of the host URL (the URL portion between the prefix and the suffix) is stored without encoding. Alternatively, a standard ASCII compression routine may be used to encode the domain.

FIG. 7 depicts a USER/AGENT protocol attribute dictionary 700 for indicating information about a USER/AGENT protocol attribute of an HTTP request packet. Dictionary 700 includes a value of HTTP for protocol designator 305 and a value of USER/AGENT for attribute designator 310. Dictionary 700 as shown includes a set of four predefined values 701-704 and corresponding field indicators 711-714. As depicted, predefined values 701-704 specify whether the client application associated with a request is Internet Explorer (711), Mozilla/Firefox (712), Safari (713), or “other” client (714).

Returning to FIG. 1, the depicted embodiment of method 100 includes encoding (block 120) in response to the protocol for the packet being validated in block 110. Conceptually, encoding 120 includes generating a representation of the network packet that (1) is suitable for later recreating desired aspects of the original network flow and (2) consumes less storage than the original network flow. As depicted in FIG. 8, one embodiment of encoding 120 includes examining (block 802) the packet to identify the presence of one or more protocol attributes contained in the packet and extracting (block 804) values associated with each of the identified protocol attributes. The extracted values are then used to access (block 806) a dictionary corresponding to the protocol attribute to obtain an encoding associated with the extracted value. The encodings are then assembled (block 808) such as by concatenating or otherwise associating the encodings with one another. For example, in the case of an HTTP request packet where the protocol attributes of interest are the TYPE, HOST, and USER/AGENT protocol attributes as described above with respect to FIG. 5, FIG. 6, and FIG. 7, the packet would be examined in block 802 to identify the three protocol attributes that are associated with dictionaries. The values for the three attributes would then be extracted in block 804. This would include extracting a value for the TYPE attribute, the HOST protocol attribute, and the USER/AGENT protocol attribute. The extracted values of the TYPE attribute would then be used to index or otherwise access predefined values of TYPE protocol attribute dictionary 500 to obtain an 8-bit encoding that indicates the request command (GET, PUT, POST, other), whether the request specified a target URL, and the protocol/version of the request, all as specified by dictionary 500. This process would be repeated for the extracted value of the HOST protocol attribute using HOST protocol attribute dictionary 600 and for the extracted value of the USER/AGENT protocol attribute using USER/AGENT protocol attribute dictionary 700. In an example based on dictionaries 500, 600, and 700, the encoding process would produce an 8-bit encoding for the TYPE attribute value, an 8-bit encoding for the HOST protocol attribute value, and a 4-bit encoding for the USER/AGENT protocol attribute value. In addition, the domain of the HOST protocol attribute would be stored without encoding. Thus, it will be appreciated by those skilled in network protocols and network communication that each HTTP request packet is represented by a 20-bit encoding and possibly a small amount of text data indicating the domain of a host URL. In contrast, the original HTTP request most likely requires more than 1000 bytes. Moreover, this encoding, when used in conjunction with dictionaries 500, 600, and 700, contains all relevant information needed to later recreate the packet for simulation or testing purposes.

Returning to FIG. 1, the assembled encodings are stored (block 125) in a storage device or region such as network flow encodings storage 400. Network flow encodings storage 400 are preferably implemented in memory. An exemplary representation of a portion of network flow encodings 400 is shown in FIG. 4 as including a set of encodings 401 through 405. Each of the encodings 401 through 405 represents a packet transmitted over the network.

Consider the portion of an HTTP request depicted in Example 1 below.

### EXAMPLE 1

### HTTP Request

GET/ HTTP/1.1
Host: www.anysite.com
User-Agent: Mozilla/5.0 (Macintosh; U; PPC Mac OS X Mach-O; en-US; rv:1.7.10) Gecko/30050716 Firefox/1.0.6
Accept: application/x-shockwave-flash,text/xml,application/xml,application/xhtml+xml,text/htm; q=0.9,text/plain
Accept-Language: en-us,en;q+=0.5
Accept-Encoding: gzip,deflate
Accept-Charset: IS)-8859-1,utf-8,q=0.7,*,q=0.7
Keep-Alive: 300
Connection: keep-alive

Assuming that HTTP is a recognized protocol, the HTTP version 1.1 protocol for this packet is validated. In the example implementation presented here, where there are three attributes of interest, a value of {GET/no URL/HTTP 1.1} is extracted and encoded as binary 1000 0001 according to dictionary 500 (where field indicator 511 is the least significant bit and field indicator 518 is the most significant bit according to dictionary 500 for the TYPE attribute), a value of {www.anysite.com} is extracted and encoded as binary 1010 0000 according to dictionary 600 where field indicator 611 is the most significant bit and field indicator 618 is the least significant bit, and a value of {MOZILLA/5.0} is extracted and encoded as binary 0100 according to dictionary 700 where field indicator 711 is the most significant bit and field indicator 714 is the least significant bit for the USER/AGENT protocol attribute.

Continuing with the preceding example, an exemplary HTTP response generated following the request depicted in Example 1 above is reflected in Example 2 below.

### EXAMPLE 2

### Initial HTTP Response

HTTP/1/1 302 Found
Date: Tue, 17 Jan 3006, 14:59:12 GMT
Server: Microsoft-IIS/6.0
X-Powered-by: ASP.NET
X-AspNet-Version: 1.1.4322
Locaton: /Home.aspx
Set-Cookie: ASP.NET_SessionId=xcmo ji j1 0uqihlziluian055; path=/
Cache-Control: private
Content-Type: text/html; charset=utf-8
Content-Length: 127
<html><head><title>Object moved</title></head><body>
<h2>Object moved to <a href=‘/HOme.aspx’>here</a>.</hs>
</body></html>

For purposes of storing this response in a form that would enable one to simulate or otherwise recreate the packet later, the attributes of interest include the response code (in this example, “302”), the server type (in this example, “Microsoft-IIS 6.0”), the content type (in this example, “text/html”) and the content-length (in this example, “127 bytes”). Analogous to the manner in which the request is encoded as described above, one or more dictionaries may be used to encode the response.

Method 100 as depicted in FIG. 1, encompasses the concept of a flow by determining (block 130) whether a request or response that has been encoded is related to a previously encoded packet (either request or response). In one embodiment, a network flow might include an initial request and all resulting responses and requests that the initial request generates. Illustrating this concept in the context of Example 1 and Example 2 depicted above, the response code shown in Example 2 was “302.” HTTP knowledgeable persons will recognize an HTTP response code of 302 as a redirection response that requires the client to issue another request to arrive at the desired result (e.g., the desired web page). In this case, the client will react to the 302 response code by generating a second request, which is part of the same network flow as the initial request because it is part of the sequence of packets generated based on the initial request.

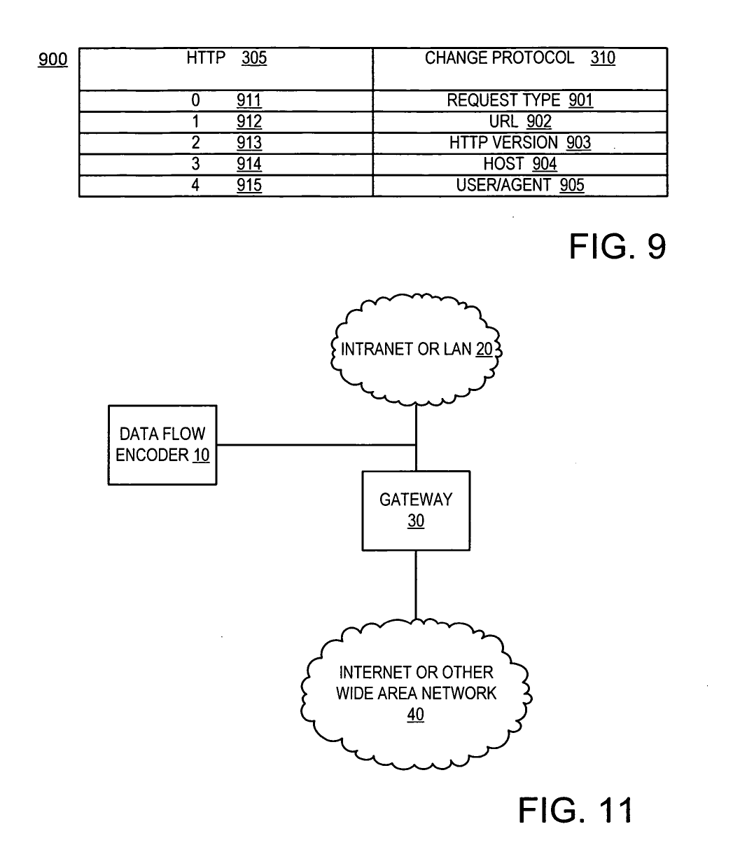

In one embodiment, the second request is encoded using the same dictionaries as the initial request. In many cases, however, the second request is likely to be different from the initial request in only one attribute (e.g., the targeted URL in the case of a redirection response). Some embodiments may take advantage of the similarity between the initial request and the second request by encoding the second request with a “change encoding” in which the attribute that differs from a previous packet is indicated and the new value of the attribute is appended to the change encoding. An exemplary CHANGE CONTROL dictionary 900 suitable for encoding change packets is depicted in FIG. 9. The depicted CHANGE CONTROL dictionary 900 includes predefined values 901-905 and corresponding field indicators 911-915 to specify which of five parameters in the second request differs from the first request. CHANGE CONTROL dictionary 900 is suitable for indicating a changed request type (911), targeted URL (912), HTTP version (913), Host (914), and/or User/Agent (915). Using the concept of control flows and change encodings, method 100 achieves even further efficiencies in condensing the representation of packets within a flow. To illustrate, the request that is generated by the client following receipt of the packet containing the response code 302 is encoded as a 5-bit encoding with appended text or compressed text indicating the URL. Returning to FIG. 1, encodings that are part of a common network flow are stored (block 135) as a flow data structure (superflow) in network flow encoding storage 400 so that the packets in the network flow can later be recreated. Alternatively, superflows can be analyzed and streamlined by eliminating the packets corresponding to requests that were ultimately redirected or that otherwise resulted in the generation of additional requests.

After the packet and flow encodings are generated and stored, a suitable application program may access the stored encodings for a variety of reasons. In one application, the stored encoding is accessed for purposes of analyzing and reporting statistics about the packets that are represented by the data. These statistics might include, as examples, the percentage of packets that are GET requests, the percentage of requests issuing from a specified host, etc. This application would have access to and an understanding of the dictionaries that would enable the program to interpret the stored encodings. The application may further include the ability to modify the stored encodings. This ability, for example, would enable a user to alter the composition of packets that are represented by the stored encodings. The ability to edit the stored encoding would preferably include an intervening graphical user interface that would present data regarding the packets to the user to enable the user to edit the stored encodings in a readable format. The user would be able to change a GET request to a POST request (for example) by replacing the text “GET” with “POST” in an appropriate field of the GUI thereby relieving the user of needing to have an understanding of the bit-by-bit or other implementation of the encodings.

In still another application, the stored encodings are retrieved and decoded for purposes of simulating packet traffic on a computer network. In this application, one or more data processing devices connected to a network and having access to the stored encodings and the dictionaries retrieve stored encodings and decode them using the dictionaries to generate protocol compliant packets from the stored encodings. Where the protocol compliant packets require content or other data that is not captured in the encoded attributes, the data processing device(s) may insert random or “dummy” data. This application is suitable for simulating packet traffic on a computer network for purposes of testing network equipment.

In some embodiments, retrieving stored packets, whether encoded or not, for purposes of transmitting emulated packets may include modifying selected information in the packets. More specifically, selected information in a packet may be specific to the environment in which the packet was captured and the time when the packet was captured. This type of information is referred to generally herein as environmental packet data or, more simply, environmental data. In some cases, merely reproducing these environment and time sensitive portions of a packet is inconsistent with the goal or simulating real world traffic on the network. As an example, many protocols implement the concept of “time to live” (TTL). TTL is a field in a packet, set by a protocol stack when a packet is created, that provides a mechanism for terminating packets that are “lost.” Each time a packet traverses a network hop, the corresponding router or other network device decrements the packet's TTL value. If the TTL value reaches zero, the packet is terminated, deleted, or otherwise eliminated. In this manner, a packet that would otherwise bounce back and forth in an endless loop dies eventually. In the context of packet capture and emulation, however, it is not necessarily desirable and may well be undesirable to reproduce the TTL of a captured packet as the TTL for the emulated packet. If a packet is captured when its TTL value is close to zero, replicating the same TTL value in the emulated packet might result in the immediate termination of the emulated packet. In one aspect, encoding application 51 and data encoder 10 include functionality that substantively modifies packet data, as opposed to merely compressing or encoding data, on a selective basis to reflect the reality that emulated packets are transmitted in a different time and context than the captured packets.

Other examples of packet information that may require substantive modification at transmission time include information relating to firewalls and network address translation (NAT) information. In many environments, firewalls convert that IP address of an originating device to a “generic” IP address that is used for the entire firewall protected domain. When a gateway receives an inbound packet, the NAT information enables the gateway to associate the packet with the appropriate source. In the context of capturing and later transmitting emulated packets, however, it may be desirable to eliminate the NAT effects and restore the captured packets to indicate their original IP addresses. As another example, packets may include timestamps and checksum values that will clearly be incorrect if merely reproduced in the emulated packet and the preferred embodiment of encoding application is enabled to generate contemporary timestamp and checksum values when the emulated packet is transmitted.

More generally, as depicted in the flow diagram of FIG. 13, a preferred embodiment of the encoding application is configured to generate emulated packets that mimic the function of the corresponding captured packet using contemporary environmental data. Thus, a transmitting portion 170 of encoder application 51 may include retrieving (block 172) an encoded packet from storage, decoding (block 174) encoded portions of the packet, modifying (block 176) environmental data in the packet, and transmitting (block 178) the decoded and environmentally modified packet.

In some embodiments, transmitting portion 170 of encoder application 51 may include decoding, modifying, and transmitting packet data in a manner that preserves packet ordering and/or packet pacing. There may be applications in which the order and/or the pacing of packets effects network performance (e.g., latency), functionality, costs, results, or some other parameter of interest. In such cases, encoding method 100 (of FIG. 1) and transmitting portion 170 (of FIG. 13) may include encoding ordering or pacing information in the stored packets and later using the ordering or pacing information to transmit emulated packets with the substantially same packet ordering and/or pacing. Although the concept of packet pacing includes the relative timing of packets, pacing may also be reflected in non-time parameters. For example, pacing may identify the number of other packets transmitted between two packets, the number of bytes transmitted between two packets, the number of times a counter (e.g., a clock cycle counter on a network interface card) increments, or even the number of different IP addresses encountered between two packets of interest. Whatever pacing parameter is encoded in the stored packets, transmitting portion 170 preferably includes the functionality to use the encoded pacing information to pace the transmitted packets to reflect the pacing parameter of interest.

It should be appreciated that portions of the present invention may be implemented as a set of computer executable instructions (software) stored on or contained in a computer-readable medium. The computer readable medium may include a non-volatile medium such as a floppy diskette, hard disk, flash memory card, ROM, CD ROM, DVD, magnetic tape, or another suitable medium. Further, it will be appreciated by those skilled in the art that there are many alternative implementations of the invention described and claimed herein. It will be apparent to those skilled in the art having the benefit of this disclosure that the present invention contemplates the processing and encoding of network flows so that the encoded results accurately emulate the original network flows, but can be stored in significantly less memory than would otherwise be required for storing the original network flows. Once encoded, characteristics and attributes of the stored network flows may be examined and, if desired, manipulated to facilitate different network flows to be emulated. The stored network flows may be decoded and transmitted for purposes of testing network components. It is understood that the forms of the invention shown and described in the detailed description and the drawings are to be taken merely as presently preferred examples and that the invention is limited only by the language of the claims.

What is claimed is:

1. A method of encoding a network packet, comprising:
determining a protocol for the packet and validating the protocol as belonging to a list of recognized protocols;
responsive to validating the packet, parsing a protocol attribute value from the packet;
referencing a dictionary using the protocol attribute value to obtain a binary encoding; and
storing the binary encoding in storage as an encoded packet.

2. The method of claim 1, wherein the packet is an HTTP protocol request packet and wherein the list of recognized protocols includes HTTP and wherein parsing a protocol attribute value from the packet includes parsing a TYPE attribute value from the packet and wherein the TYPE attribute value is indicative of whether the packet is a GET, POST, PUT or OTHER type of HTTP request.

3. The method of claim 2, wherein referencing a dictionary comprises referencing a TYPE dictionary, wherein the TYPE dictionary defines a set of bits indicative of the type of HTTP request.

4. The method of claim 2, wherein the TYPE attribute value is further indicative of an HTTP protocol version associated with the packet and wherein the TYPE dictionary defines a set of bits indicative of the HTTP protocol version.

5. The method of claim 4, wherein the TYPE attribute value is further indicative of whether the packet includes a target URL and wherein the TYPE dictionary defines a bit indicative of whether the packet includes a target URL.

6. The method of claim 2, wherein parsing a protocol attribute value from the packet further includes parsing a HOST attribute value from the packet, wherein the HOST attribute value is indicative of a host URL associated with the packet.

7. The method of claim 6, wherein referencing a dictionary includes referencing a HOST dictionary, wherein the HOST dictionary defines a set of bits indicative of a host URL associated with the packet.

8. The method of claim 7, wherein the HOST dictionary defines a first set of bits indicative of the prefix of the host URL and a second set of bits indicative of a suffix of the host URL.

9. The method of claim 6, wherein parsing a protocol value further comprises parsing a USER/AGENT attribute value from the packet and wherein referencing a dictionary comprises referencing a USER/AGENT dictionary indicative of a client application associated with the packet.

10. The method of claim 9, wherein the USER/AGENT dictionary includes a set of bits indicative of the client application.

11. The method of claim 9, wherein the encoding includes a set of bits indicative of the type of request packet, a set of bits indicative of the host URL, and a set of bits indicative of the client application.

12. The method of claim 1, further comprising associating a first binary encoding associated with a first packet with a second binary encoding associated with a second packet, the second packet being related to the first packet.

13. The method of claim 12, wherein the second packet and the first packet are associated with a common initial request packet.

14. The method of claim 13, further comprising merging the first binary encoding with the second binary encoding to generate a third binary encoding, wherein the third binary encoding represents a cumulative effect of the first and second binary encoding.

15. The method of claim 13, wherein the second binary encoding is a change encoding indicative only of attribute values in the second packet that differ from corresponding packet values in the first packet.

16. The method of claim 1, further comprising:
retrieving the encoded packet from storage and referencing the dictionary using the encoding to obtain a protocol attribute value; and
generating an emulated packet suitable for transmission from the encoded packet based at least in part on the protocol attribute value.

17. The method of claim 16, wherein generating the emulated packet includes replacing captured environmental data in the encoded packet with contemporary environmental data to reflect a time and a network environment in which the emulated packet is to be transmitted.

18. The method of claim 17, wherein the environmental data is selected from the group consisting of, network address translation (NAT) information, checksum information, and time to live (TTL) information.

19. The method of claim 16, further comprising, including in the encoded packet information indicative of a pacing of the packet relative to other packets.

20. The method of claim 19, wherein the pacing indicative information is selected from the group consisting of number of packets transmitted between two packets, the number of bytes transmitted between two packets, and the number of times a network interface card clock cycle counter increments.

21. The method of claim 19, further comprising retrieving and using the pacing indicative information to preserve the recorded pacing when transmitting the emulated packet.

22. The method of claim 1, further comprising responsive to not validating the packet, recording the packet as an unrecognized packet and determining whether a sufficient sample of unrecognized packets have been recorded.

23. The method of claim 19, further comprising, responsive to determining that a sufficient sample of unrecognized packets have been recorded, creating a new encoding for the unrecognized packets by identifying patterns in the bits of the unrecognized packets.

24. A computer instruction product comprising computer executable instructions, stored on a computer readable medium for encoding a network packet, the instructions comprising:
instructions for determining a protocol for the packet and validating the protocol as belonging to a list of recognized protocols;
responsive to validating the packet, instructions for parsing a protocol attribute value from the packet;
instructions for referencing a dictionary using the protocol attribute value to obtain a binary encoding; and
instructions for storing the binary encoding in storage as an encoded packet.

25. The computer program product of claim 1, further comprising:
instructions for retrieving the encoded packet from storage and referencing the dictionary using the encoding to obtain a protocol attribute value; and
instructions for generating an emulated packet suitable for transmission from the encoded packet based at least in part on the protocol attribute value.

26. The computer program product of claim 25, wherein the instructions for generating the emulated packet include instructions for replacing captured environmental data in the encoded packet with contemporary environmental data to reflect a time and a network environment in which the emulated packet is to be transmitted.

27. The computer program product of claim 26, wherein the environmental data is selected from the group consisting of, network address translation (NAT) information, checksum information, and time to live (TTL) information.

28. The computer program product of claim 25, further comprising, instructions for including in the encoded packet information indicative of a pacing of the packet relative to other packets.

29. The computer program product of claim 28, wherein the pacing indicative information is selected from the group consisting of number of packets transmitted between two packets, the number of bytes transmitted between two packets, and the number of times a network interface card clock cycle counter increments.

30. The computer program product of claim 28, further comprising instructions for retrieving and using the pacing indicative information to preserve the recorded pacing when transmitting the emulated packet.

31. The computer program product of claim 24, further comprising, responsive to not validating the packet, instructions for recording the packet as an unrecognized packet and determining whether a sufficient sample of unrecognized packets have been recorded.

32. The computer program product of claim 31, further comprising, responsive to determining that a sufficient sample of unrecognized packets have been recorded, instructions for creating a new encoding for the unrecognized packets by identifying patterns in the bits of the unrecognized packets.

33. A data processing system including a processor, a computer readable storage medium accessible to the processor, and software stored on the computer readable storage medium, the software comprising computer executable instructions including:
instructions for determining a protocol for the packet and validating the protocol as belonging to a list of recognized protocols;
responsive to validating the packet, instructions for parsing a protocol attribute value from the packet;
instructions for referencing a dictionary using the protocol attribute value to obtain a binary encoding; and
instructions for storing the binary encoding in storage as an encoded packet.
